(19) United States
(12) Patent Application Publication
(10) Pub. No.: US 2023/0032973 A1
(43) Pub. Date: Feb. 2, 2023

(54) SYSTEM AND METHOD FOR FACILITATING CREDITOR AND CONSUMER TRANSACTIONS

(71) Applicant: H2H Technologies, Las Vegas, NV (US)

(72) Inventors: Donna Ann WEAVER, Woodland, CA (US); Prateek GUPTA, Kolkata (IN)

(73) Assignee: H2H Technologies, Las Vegas, NV (US)

(21) Appl. No.: 17/544,619

(22) Filed: Dec. 7, 2021

Related U.S. Application Data
(60) Provisional application No. 63/227,596, filed on Jul. 30, 2021.

(51) Int. Cl. G06Q 40/02; G06Q 20/36

(52) U.S. Cl. CPC G06Q 40/025; G06Q 20/3678

(57) ABSTRACT

A method, system, apparatus, and computer program product for accessing and communicating data between accounts, including incentives for their use. Consumers, businesses, creditors, and agencies may be allowed to create and manage a centralized collections account. Consumers may be able to pay, negotiate, and manage their past due debt accounts within the centralized collections account. Businesses, creditors, and agencies may be able to negotiate with customers, manage clients and sub clients, and set legal terms and conditions within the centralized collections account. Rewards may be earned for negotiating and paying off a collections account or assisting others in these actions. Businesses, creditors, and agencies may be able to electronically communicate amongst themselves and with consumers, potentially reducing postal and telephone expenses.

### CROSS-REFERENCE TO RELATED APPLICATIONS

The present application claims priority to U.S. Provisional Application No. 63/227,596, filed Jul. 30, 2021 and entitled “SYSTEM FOR A GLOBAL BILL PAY NETWORK APPLICATION”, the contents of which are herein incorporated by reference in their entirety.

### BACKGROUND

Past due debt is common, with 1 in 4 people having at least one account in collections. In fact, there is an estimated $660 billion in collection account balances in the United States alone with over $1 trillion in student loan debt. There is only a 20% recovery rate for collection amounts and over $65 billion of past due debt is charged off each year by banks alone. Financial stress is a leading factor in divorce, insomnia, and suicidal cases.

The account collection industry is typically performed manually through phone calls and postal mail. About 98% of consumers have a smart phone but do not answer calls from unknown numbers and tend to not open postal mail. These factors make it difficult for collection agencies to recover past due debt. Also, individuals may not be incentivized to pay off collection amounts because of financial hardship, the confusing process of contacting a collection agency or former lender and may have an unknown amount of outstanding debt balances.

### SUMMARY

A method, system, apparatus, and computer program product for accessing and communicating data between accounts, including incentives for their use. Consumers, businesses, creditors, and agencies may be allowed to create and manage a centralized collections account. Consumers may be able to pay, negotiate, and manage their past due debt accounts within the centralized collections account. Businesses, creditors, and agencies may be able to negotiate with customers, manage clients and sub clients, and set legal terms and conditions within the centralized collections account. Rewards may be earned for negotiating and paying off a collections account or assisting others in these actions. Businesses, creditors, and agencies may be able to electronically communicate amongst themselves and with consumers, potentially reducing postal and telephone expenses.

### BRIEF DESCRIPTIONS OF THE DRAWINGS

The accompanying drawings illustrate various embodiments of systems, methods, and various other aspects of the embodiments. Any person with ordinary skills in the art will appreciate that the illustrated element boundaries (e.g., boxes, groups of boxes, or other shapes) in the figures represent an example of the boundaries. It may be understood that, in some examples, one element may be designed as multiple elements or that multiple elements may be designed as one element. In some examples, an element shown as an internal component of one element may be implemented as an external component in another, and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 shows an exemplary method for facilitating creditor and consumer transactions.

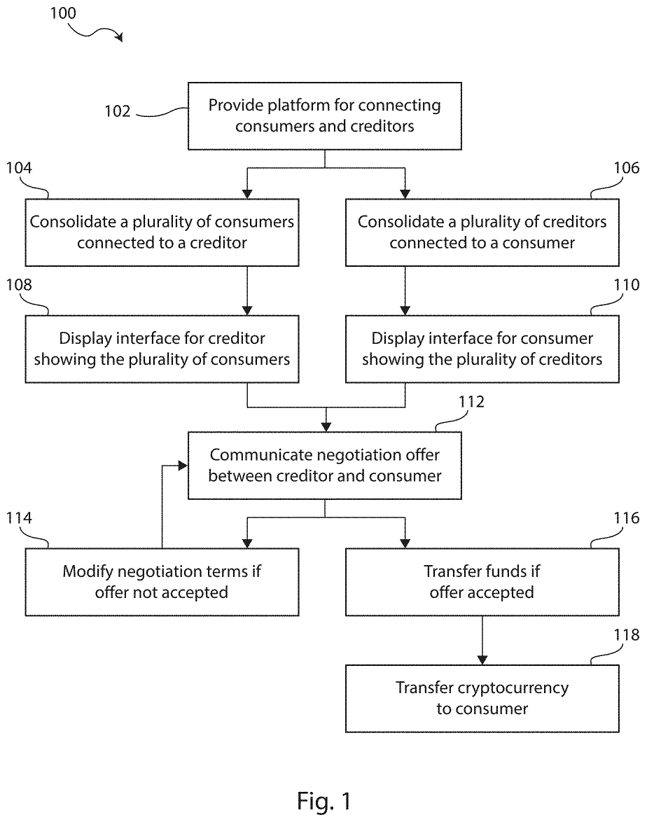

FIG. 2 shows an exemplary method for facilitating contributor and consumer transactions.

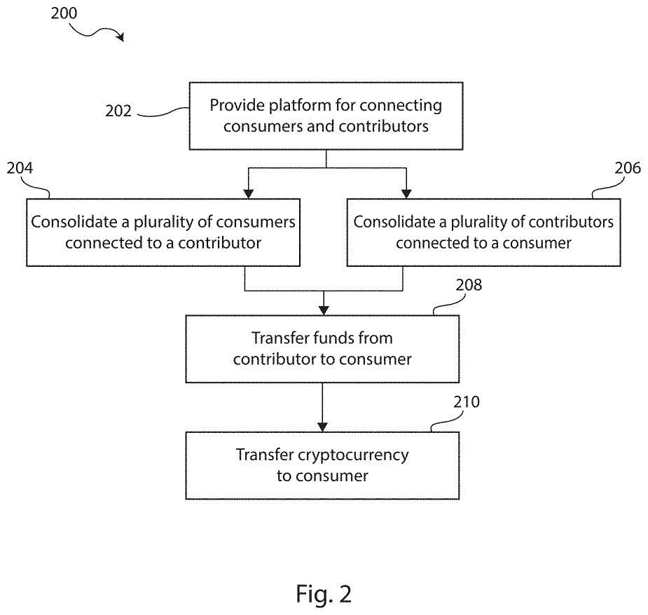

FIG. 3 shows an exemplary method for facilitating creditor and consumer transactions.

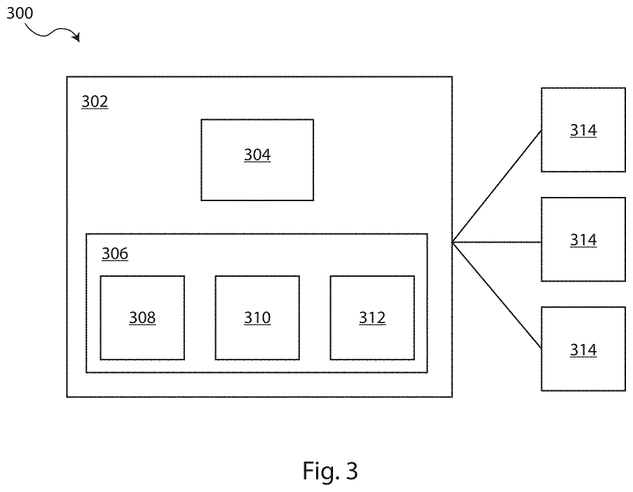

### DETAILED DESCRIPTION OF THE EMBODIMENTS

Aspects of the present invention are disclosed in the following description and related figures directed to specific embodiments of the invention. Those of ordinary skill in the art will recognize that alternate embodiments may be devised without departing from the spirit or the scope of the claims. Additionally, well-known elements of exemplary embodiments of the invention will not be described in detail or will be omitted so as not to obscure the relevant details of the invention.

As used herein, the word exemplary means serving as an example, instance or illustration. The embodiments described herein are not limiting, but rather are exemplary only. The described embodiments are not necessarily to be construed as preferred or advantageous over other embodiments. Moreover, the terms embodiments of the invention, embodiments or invention do not require that all embodiments of the invention include the discussed feature, advantage, or mode of operation.

Further, many of the embodiments described herein are described in terms of sequences of actions to be performed by, for example, elements of a computing device. It should be recognized by those skilled in the art that the various sequence of actions described herein can be performed by specific circuits (e.g., application specific integrated circuits (ASICs)) and/or by program instructions executed by at least one processor. Additionally, the sequence of actions described herein can be embodied entirely within any form of computer-readable storage medium such that execution of the sequence of actions enables the processor to perform the functionality described herein. Thus, the various aspects of the present invention may be embodied in several different forms, all of which have been contemplated to be within the scope of the claimed subject matter. In addition, for each of the embodiments described herein, the corresponding form of any such embodiments may be described herein as, for example, a computer configured to perform the described action.

With respect to the embodiments, a summary of terminology used herein is provided.

A creditor can be any business that is extending services for credit to a consumer. For example, credit card, auto, and mortgage providers, hospitals, doctor offices, attorneys, utilities, etc. A consumer can be the recipient of a credit line, limit, or service.

A global bill pay network application (“GBPNA”) may utilize a centralized network allowing management of collection and bill accounts for consumers, creditors, businesses, and agencies. The centralized network may differentiate the GBPNA from software as a service (“SaaS”). For example, SaaS may require installation or implementation of software whereas the GBPNA may not require installation or implementation of software because it may utilize a centralized network. Consumers, creditors, agencies, and businesses may be able to connect to the GBPNA in real time.

The GBPNA may also be a single application compatible with multiple languages and multiple currencies. The GBPNA may allow a user to centrally access and pay all their collection and bill accounts from an account portal. Further, the GBPNA may allow for management of all payments and methods, thereby potentially avoiding disclosure of consumer payment information to creditors or third-party agencies. The GBPNA may accept all forms of payments for collection accounts. For example, the GBPNA may accept ACH, credit cards, Venmo, PayPal, Cash App, or cryptocurrency. The GBPNA may utilize Web 3.0 to accept, process, and reward digital currency to consumers while running the GBPNA on a centralized network. In another embodiment, the GBPNA may be built with credit reporting agency requirements. This may allow the GBPNA to connect to credit bureaus to report billing and credit information and potentially increase a consumer's credit score.

The GBPNA may allow consumers to create an application account which may allow them to connect to collection agencies, creditors, and businesses. Because the GBPNA may be connected to credit bureaus, consumers may be able to see all their collection or bill accounts without needing to individually contact creditors or agencies. This may result in consumers needing only a single set of account credentials to access all their collection accounts. Also, consumers' credit scores may be boosted because the GBPNA may report both CRA and non-CRA accounts to credit bureaus. Consumers may also set up a permissible purpose profile within their account to receive all notices and communications from collection agencies or banks. Consumers may be able to use their account to change a payment method, update an email, phone number, or address, and send the updated information to potential creditors or agencies. Consumers may be able to pay, negotiate, and send negotiation offers to creditors or third-party agencies centrally or digitally. Further, consumers may be able to skip a payment, cancel a payment, or renegotiate the terms of a past due debt account or bill within the GBPNA.

In another embodiment, the GBPNA may allow a creditor to create a master account that may house and allow the creditor to connect multiple merchant accounts and sub clients. The multiple merchant accounts may be sorted by division, customer, or subsidiary. Also, any business may be able to connect to the GBPNA using, for example, any-to-any mapping, so as to upload consumer accounts and records. For example, a business may be able to quickly connect to the GBPNA using any-to-any mapping which may leverage their existing technologies to upload consumer accounts and records. Further, creditors may be able to send their customers a link via any communication means, for example, text messaging and/or email, to log into an account to pay, negotiate, and/or send an offer to avoid charge off collection amounts. Users may use their social security number or tax identification number, or any other suitable credentials, for login and authentication. For example, a bank may send a consumer a link to log into an account that lists the consumer's collection amount and potentially allows the consumer to pay, negotiate, and/or send an offer to the bank. This may potentially save the bank outgoing call expenses. Creditors and agencies may be able to receive and respond to digital offers from a consumer at any time.

In another embodiment, creditors may export their files from their billing system in any layout and format and utilize the any-to-any mapping system (“AAMS”) to upload the file into the GBPNA. Further, the AAMS may enable the creditor to map the fields quickly and easily in the file to create a profile. The AAMS may allow creditors to rename five or more additional mapping fields, push custom data into those fields in the system, and generate reports from the mapping fields. For example, a creditor may be able to rename mapping fields to add parameters for car model, loan type, etc. and generate reports from that customized mapping field data.

In another embodiment, the GBPNA may allow creditors, businesses, and agencies to obtain a subdomain. The subdomain may be created manually or automated by an administrator. The subdomain may include secure sockets layer or SSL support. For example, a creditor named “Loan Pal” may be able to obtain a subdomain like “http://loanpal.younegotiate.com” or if it wanted SSL support the subdomain may be “https://loanpal.younegotiate.com.”

In another embodiment, the GBPNA may allow businesses, creditors, and agencies to utilize a 4-way discount and auto-approval system which may use CSV files, a custom data file created by a group of consumers, a sub-client account, or by a set of master terms. The 4-way discount and auto-approval system may allow businesses, creditors, and agencies to instantly notify consumers if the consumer's offer is within a threshold for approval or if they have been approved for a discount on their collection balance. For example, Consumer X may offer to pay $150 a month for 12 months to Creditor Y instead of paying the full balance of $6,000. Creditor Y may be utilizing the 4-way discount and auto-approval system which may require that consumers pay at least $200 to be auto-approved or have an outstanding balance of $5,000 or greater to receive a discount. Because Consumer X offered $150, the offer may not be auto-approved but Consumer X may receive a discount on the outstanding balance.

The GBPNA may create a cryptocurrency wallet for each enrolled consumer. The GBPNA may allow consumers to earn cryptocurrency rewards for paying their bills, negotiating payment plans, or sending offers. The GBPNA may allow contributors or crowd funders to assist other people in paying off debt by designating a money amount to an account—which notates that the money can only be used to pay bills or debt—and is targeted at a specific individual, geographic region, age, sex, gender, or other demographic information. For example, a contributor may want to assist a particular consumer, individuals living in a particular location, and individuals over a certain age, by designating $100 or any other money amount—usable only for paying off debt—to their respective accounts. Contributors or crowd funders may earn cryptocurrency rewards for assisting other consumers in paying off debt. For example, a contributor may assist a consumer in paying off their debt and the contributor may earn a cryptocurrency reward. Creditors and business owners may be able to choose a date to digitally sell collection or bill accounts with bad or unrecovered debt to consumers, contributors, crowd funders, or the marketplace. This may create a win-win-win reward system wherein the creditor wins by receiving the collection amount, the consumer wins by paying off debt, potentially raising their credit score, and earning a cryptocurrency reward, and the contributor or crowd funder wins by receiving a cryptocurrency reward for assisting in paying a collection or bill account.

The GBPNA may also utilize a paperless mailbox system to allow a consumer to receive electronic communications instead of physical mail. For example, a consumer may choose to use the paperless mailbox system and stop receiving mail, thereby potentially reducing postage costs, and adding an extra layer of security by only having communications accessible through the user's account. Further, consumer communication may be built into the GBPNA thereby potentially avoiding communications outside of the GBPNA. The GBPNA may allow creditors to create custom communications by demographic, age, sex, gender, age of account, sub account, payment status age of account, deadline of account for payment, expiration dates, charge off dates, and third-party new placements. The GBPNA may also collect consumer profile information to provide to first and third-party agencies, thereby potentially saving them money from mailing and data expenses.

A creditor profile account with the GBPNA may contain information about the creditor. The information may contain, but is not limited to, a company name, an industry type, a tax ID, a legal address, and a custom URL for the creditor, third party, or business. Businesses, creditors, and agencies may also be able to create a personalized logo for their account with the GPBNA. The personalized logo may be a variation of the GBPNA logo. A personalized logo creation tool may include interfaces for selecting primary, secondary, and background colors for the logo.

Creditors may be able to manage, edit, update, or remove their legal terms and conditions for customer payment. The legal terms and conditions may be applied specifically to a client, a set of clients, or to all clients. For example, a business may create legal terms and conditions for a first client and separate legal terms and conditions for a second client, as well as different terms and conditions for first group of clients, a second group of clients, and a plurality of sub-client groups within the client groups, and so forth.

Creditors may be able to establish four main negotiation terms: a pay in full balance discount percentage for offering discounts on payments made in full, a payment plan balance discount percentage for offering discounts for setting up a payment plan with the creditor, a minimum monthly payment percentage of balance, and a maximum number of days to receive the first payment plan payment. For example, a creditor may establish that the pay in full balance discount percentage is 15%, the payment plan balance discount percentage is 10%, the minimum monthly payment percentage of balance is 20%, and the maximum number of days to receive the first payment plan payment is 30 days.

Creditors may also establish hierarchical groups of consumers, based on predetermined criteria. Main groups in the hierarchy may include pluralities of sub-client groups, and further sub-client groups, with different terms and conditions (or differing portions of terms and conditions) for each group or sub-client group, as desired. Additionally, creditors can establish different values for some or all of the negotiation terms for each group or sub-group in the hierarchy. Information about sub-clients can include the name of the sub-client, the level of the sub-client in the hierarchy, the top-level group (for example a company or agency) to which the sub-client is assigned, the pay in full and payment plan discounts, the minimum monthly pay, the accepted payment methods, and the revenue share, if any, with the sub-client.

Creditors may be able to create sub-accounts and client special rules. The sub-accounts may include information that may contain, but is not limited to, the company name, industry type, address, and tax ID. Client special rules may contain, but are not limited to, who responds to consumer offers provided by the GBPNA interface, who sets the negotiation terms, where to deposit funds, a paid-in-full discount amount, a minimum monthly payment amount, a list of accepted payment methods, and a revenue share amount for the sub accounts.

Creditors may upload and import exported customer files from their existing technologies. For example, a creditor may import a CSV or other data file containing customer information. Creditors may also be able to map fields within the GBPNA to fields within their own data file. For example, a creditor may map an “account number” field within the GBPNA to an “account” field within their uploaded data file.

Creditors may be able to create campaign templates within the GBPNA. These campaign templates may include a template name, template type, such as email or SMS, and a template message. The campaign templates may be assigned to a selected group, such as, “Not Joined Yet”, “Joined but No Deal”, “Successful Payment Setup”, “Paid in Full”, and so forth. The further groups may be defined, added, or removed as desired by the creditor. There may be a template library which may include all the templates created with information such as, the template name, type, date of creation, and author. The template library may also include available actions to take, such as, sending the template, opening the template, editing the template, or deleting the template.

The GBPNA may provide a dashboard for a creditor, showing aggregate information and detailed information. The aggregate information can include the total number of accounts uploaded by the creditor, the total amount of consumers connected to the creditor via the GBPNA, the total value of customer payments made during a predetermined period of time, and the total value of upcoming scheduled payments. The detailed information can include lists of open negotiation offers and recent transactions. The list of open negotiation offers can show open offers that consumers have made to the creditor. The open negotiation offers list may include information about the negotiation offer such as, a customer name, an account number, a client name, an account balance, a loan original date, a placement date, a deadline to help date, and an action to take, such as viewing the offer. The list of recent transactions can show recently performed transactions with detailed information such as, a date and time, a customer name, an account number, a client name, a transaction type, a transaction ID, a payment mode, a transaction value amount, and a status, such as failed, submitted, settled, or in progress.

When viewing an open negotiation offer, creditors may see parameters for the creditor's offer, as well as parameters for the consumer's counter offer. The parameters include the values for the four main negotiation terms, as described above. Any communications or notes submitted by the consumer with the counter offer can also be viewed. Creditors may be able to perform actions such as, for example, accept the offer, counter the offer, ask the client about the offer, contact the customer, or decline the offer. The negotiation offer may also include the above information on the open negotiation offers interface as well as notes from the consumer. Each negotiation offer may initially be based on the four main negotiation terms.

A plurality of negotiation attempts, up to a predetermined limit, for example three attempts, may be facilitated by the GBPNA between a creditor and a consumer. If the consumer is unable to meet the requirements of the main negotiation terms, the GBPNA can provide the consumer with a final offer based on the creditor's term requirements. If the consumer is unable to afford the final offer, the GBPNA may ask the consumer to send the creditor a custom offer that they can afford, along with reasons why the consumer cannot meet the terms of the prior offers. If necessary, terms may be updated “on-the-fly” for a particular consumer.

Creditors may be able to create communication groups within the GBPNA. The communication groups may require information such as the group name, the group description, the customer type, account rules to select customers, or an attached template. Creditors may be able to preview the communication group size, save the communication group, and save and send the attached template. For example, a business may create a communication group titled, “Failed Payments” with a description of, “This group is for consumers whose payment failed,” with the customer type as “Failed Payments.” Communication campaigns may be tracked, and data as to the number of customers in the group, the total sent, delivered, and failed messages, and the balance value delivered, may be shown for each communication campaign.

Creditors may be able to schedule automated exports of data within the GBPNA. The export may require information such as, an export type, a client, a frequency, a delivery type, etc. For example, a business may schedule an export of data, as a CSV file, from a particular client, every night, and sent by email. The export reports may also assist in saving time and money because of the automation feature.

Consumers may be able to create an account and profile within the GBPNA. The consumer profile may require information such as a first name, a last name, the last four digits of a social security number, a date of birth, and address, and any other desired information. The consumer may be able to update the profile information at any given time.

A consumer may be able to view an account dashboard that may show one or more accounts linked to the consumer. The consumer account dashboard may list a snapshot or overview of the consumer accounts. The consumer account dashboard may include, for example, an account number, an account name, a creditor name, a balance amount, a status of the account, and an action, such as, negotiate, set up payment, view counteroffer, open account, view plan, or view last offer. Statuses of the account may inform the consumer of the current status of the account, such as, for example, ready to negotiate, offer sent, offer/counteroffer received, approved, pending payment set up, successful payment, failed payment, payment plan in place, and so forth.

Consumer payoff options may allow the consumer to see a payoff amount. For example, the payoff amount may show information such as, the creditor name, account number, current balance, any payoff discounts, and annual interest accrual. Also, the consumer payoff options may allow the consumer to establish an offer or settlement wherein the consumer may set a payment frequency, a payment amount, and a first payment date and submit an offer. The consumer may be provided information as to a discounted amount to settle the debt. The consumer payoff options may also allow the consumer to select a contact preference, select a reason for the offer or settlement, and include any relevant notes.

Consumer payment methods facilitated by the GBPNA may include a credit or debit card, a bank account, a PayPal account, a Cash App account, or a Venmo account, and so forth. The consumer payment method may include an e-Sign wherein the consumer may agree to pay a scheduled amount according to an agreement. For example, a consumer may utilize her bank account to submit an ACH payment and may select to e-Sign an agreement.

Alternate options may be provided to a consumer, and may allow a consumer to adjust the date of a payment or to skip a payment. If desired, skipping a payment may only be performed a predetermined number of times. The alternate options interface may also provide information such as, a scheduled date, a payment method, a payment amount, and an action such as change date or skip payment.

The GBPNA may provide consumers with cryptocurrency rewards. The cryptocurrency reward may start with a consumer, contributor, or crowd funder, paying off past due debt. Contributors and crowd funders may help other consumers pay off their debts. Next, the consumer, contributor, or crowd funder, may earn cryptocurrency which may be stored in their cryptocurrency wallet. Finally, the consumer, contributor, or crowd funder may check their cryptocurrency amount within their account.

According to an exemplary embodiment, a method 100 for facilitating creditor and consumer transactions is disclosed. At step 102, a platform for connecting a plurality of consumers and a plurality of creditors may be provided. A consumer of the plurality of consumers may be connected to one or more creditors of the plurality of creditors, and a creditor of the plurality of creditors may be connected to one or more consumers of the plurality of consumers. At step 104, the one or more consumers that are connected to the creditor may be consolidated. At step 106, the one or more creditors that are connected to the consumer may be consolidated. At step 108, an interface for the creditor showing the one or more consumers that are connected to the creditor may be displayed. At step 110, an interface for the consumer showing the one or more creditors that are connected to the consumer may be displayed. At step 112, one or more negotiation offers between the creditor and the consumer may be communicated, via interfaces displayed to the creditor and the consumer. The negotiation offers may be subject to negotiation terms provided by the creditor. At step 114, the negotiation terms may be modified if the negotiation terms are not accepted by the consumer. At step 116, a transfer of funds from the consumer to the creditor may be facilitated if the negotiation terms are accepted by the consumer and the creditor. Furthermore, at step 118, a cryptocurrency reward may be sent to a cryptocurrency wallet of the consumer, as a reward for the transfer of funds from the consumer to the creditor.

According to another exemplary embodiment, a method 200 for facilitating contributor and consumer transactions is disclosed. At step 202, a platform for connecting a plurality of consumers and a plurality of contributors may be provided. A consumer of the plurality of consumers may be connected to one or more contributors of the plurality of contributors, and a contributors of the plurality of contributors may be connected to one or more consumers of the plurality of consumers. At step 206, an interface for the contributors showing the one or more consumers that are connected to the contributors may be displayed. At step 208, a transfer of funds from the contributor to the consumer may be facilitated, and the funds may only be further transferable from the consumer to a creditor. Furthermore, at step 210, a cryptocurrency reward may be sent to a cryptocurrency wallet of the contributor, as a reward for the transfer of funds from the contributor to the consumer.

According to another exemplary embodiment, a system 300 for facilitating creditor and consumer transactions is disclosed. The system 300 may include at least one central server 302, which may further include at least one data storage 304 for storing the GBPNA and the data utilized by the GBPNA and at least one processor 306 for executing the instructions of the GBPNA. Central server 302 may be in communication with a plurality of user terminals 314, which may be any known computing or portable electronic device that allows the GBPNA to function as described herein. The user terminals may be used by consumers, creditors, and contributors. A plurality of creditor accounts 308, consumer accounts 310, and contributor accounts 312 may be stored on data storage 304 and accessible via user terminals 314.

In summary, the GBPNA according to the present disclosure may be an any-to-any global rewards payment network for billing and collection accounts. Consumers may not need to know their account numbers or to know where their accounts are to make payments and manage payment plans and creditors across all industries. Furthermore, creditors and other third party agencies such as, for example, law firms can upload accounts in any format or layout, set terms and discounts, and instantly accept traditional and non-traditional forms of payment from their customers. The GBPNA can allow creditors to generate an embed code to add the logo for the GBPNA to their website as well as a QSR code. Consumers can create their profile account with communication permissions, allowing them to quickly log in any time from a mobile application utilizing a single username and password to access all their accounts or to reply to communications to make instant payments on text and email offers. The GBPNA can further reward consumers by allowing them to earn cryptocurrency and monetary rewards every time the consumers make progress on their accounts. Furthermore, consumers can provide communication permissions for billing and collections and the GBPNA can offer a batch service to creditors so as to provide such data, and thereby reduce the creditors' expense of acquiring contact and location data.

The foregoing description and accompanying figures illustrate the principles, preferred embodiments, and modes of operation of those embodiments. However, the embodiments should not be construed as being limited to the embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

1. A method comprising:
providing a platform for connecting a plurality of consumers and a plurality of creditors, wherein a consumer of the plurality of consumers is connected to one or more creditors of the plurality of creditors, and a creditor of the plurality of creditors is connected to one or more consumers of the plurality of consumers;
consolidating, for the consumer, the plurality of creditors, wherein, after the consolidation, only a single set of account credentials provides access on a centralized network to all collection accounts from the plurality of creditors;
displaying an interface for the consumer, wherein the consumer accesses all collection accounts, in real time on the centralized network, from the plurality of creditors from a mobile application with a single username and password;
communicating one or more negotiation offers between the creditor and the consumer, via the interface displayed to the consumer, wherein the negotiation offers are subject to negotiation terms provided by the creditor;
determining either that the negotiation terms are not accepted by the consumer or that the negotiation terms are accepted by the consumer and the creditor;
modifying the negotiation terms after the negotiation terms are not accepted by the consumer; and
facilitating a transfer of funds from the consumer to the creditor after the negotiation terms are accepted by the consumer and the creditor.

2. The method of claim 1, further comprising:
providing a cryptocurrency wallet for the consumer;
sending a cryptocurrency reward to the consumer upon the transfer of funds from the consumer to the creditor.

3. The method of claim 1, further comprising:
providing a platform for connecting the plurality of consumers and a plurality of contributors, wherein the consumer of the plurality of consumers is connected to one or more contributors of the plurality of contributors, and a contributor of the plurality of contributors is connected to one or more consumers of the plurality of consumers;
providing a cryptocurrency wallet for the consumer;
displaying an interface for the contributor;
facilitating a transfer of funds from the contributor to the consumer, wherein the funds are only further transferrable from the consumer to the creditor.

4. The method of claim 3, further comprising:
providing a cryptocurrency wallet for the contributor;
sending a cryptocurrency reward to the contributor upon the transfer of funds from the contributor to the consumer.

5. The method of claim 1, further comprising:
creating, for the creditor, one or more hierarchical groups of clients and sub-clients.

6. The method of claim 5, further comprising:
differentiating the negotiation terms for the one or more hierarchical groups of clients and sub-clients.

7. A-non-transitory medium having a computer-readable program code embodied therein that is configured to execute instructions that facilitate transactions between creditors and consumers, the non-transitory medium comprising:
instructions for providing a platform for connecting a plurality of consumers and a plurality of creditors, wherein a consumer of the plurality of consumers is connected to one or more creditors of the plurality of creditors, and a creditor of the plurality of creditors is connected to one or more consumers of the plurality of consumers;
instructions for consolidating, for the consumer, the plurality of creditors, wherein, after the consolidation, only a single set of account credentials provides access on a centralized network to all collection accounts from the plurality of creditors;
instructions for displaying an interface for the consumer, wherein the consumer accesses all collection accounts, in real time on the centralized network, from the plurality of creditors from a mobile application with a single username and password;
instructions for communicating one or more negotiation offers between the creditor and the consumer, via the interface displayed to the consumer, wherein the negotiation offers are subject to negotiation terms provided by the creditor;
instructions for modifying the negotiation terms after the negotiation terms are not accepted by the consumer; and
instructions for facilitating a transfer of funds from the consumer to the creditor after the negotiation terms are accepted by the consumer and the creditor.

8. The non-transitory medium of claim 7, further comprising:
instructions for providing a cryptocurrency wallet for the consumer; and
instructions for sending a cryptocurrency reward to the consumer upon the transfer of funds from the consumer to the creditor.

9. The non-transitory medium of claim 7, further comprising:
instructions for providing a platform for connecting a plurality of consumers and a plurality of contributors, wherein a consumer of the plurality of consumers is connected to one or more contributors of the plurality of contributors, and a contributor of the plurality of contributors is connected to one or more consumers of the plurality of consumers;
instructions for providing a cryptocurrency wallet for the consumer;
instructions for displaying an interface for the contributor; and
instructions for facilitating a transfer of funds from the contributor to the consumer, wherein the funds are only further transferrable from the consumer to the creditor.

10. The non-transitory medium of claim 9, further comprising:
instructions for providing a cryptocurrency wallet for the contributor; and
instructions for sending a cryptocurrency reward to the contributor upon the transfer of funds from the contributor to the consumer.

11. The non-transitory medium of claim 7, further comprising:
instructions for creating, for the creditor, one or more hierarchical groups of clients and sub-clients.

12. The non-transitory medium of claim 11, further comprising:
instructions for differentiating the negotiation terms for the one or more hierarchical groups of clients and sub-clients.
